(19) United States
(12) Patent Application Publication
(10) Pub. No.: US 2023/0262194 A1
(43) Pub. Date: Aug. 17, 2023

(54) IMAGE GENERATION METHOD, IMAGE GENERATION SYSTEM, AND RECORDING MEDIUM STORING PROGRAM

(71) Applicant: SEIKO EPSON CORPORATION, Tokyo (JP)

(72) Inventors: Kazuyoshi KITABAYASHI, Azumino-shi (JP); Keisuke HIGASHI, Azumino-shi (JP); Manae MIYATA, Kitaazumi-gun (JP); Akihiko TAMURA, Matsumoto-shi (JP)

(73) Assignee: SEIKO EPSON CORPORATION, Tokyo (JP)

(21) Appl. No.: 18/169,062

(22) Filed: Feb. 14, 2023

(30) Foreign Application Priority Data
Feb. 15, 2022 (JP) 2022-021069

(51) Int. Cl. H04N 5/74; G06T 5/50; G06T 7/50; G06T 7/70; G06V 10/25

(52) U.S. Cl. CPC H04N 5/74; G06T 5/50; G06T 7/50; G06T 7/70; G06V 10/25; G06T 2207/20221

(57) ABSTRACT

An information processing apparatus causes a display apparatus to display a superimposed image obtained by superimposing a material image applied with transmission processing on a captured image obtained by imaging a projection target object, which is a projection target of an image from a projector, with a camera and a user interface image for receiving an input for determining a position of the camera. The information processing apparatus generates projection image data representing a projection image by correcting the material image according to a three-dimensional shape measured based on a captured image obtained by imaging, from the determined position, with the camera, the projection target object onto which a pattern image for three-dimensional measurement is projected from the projector and outputs the projection image data to the projector.

The present application is based on, and claims priority from JP Application Serial Number 2022-021069, filed Feb. 15, 2022, the disclosure of which is hereby incorporated by reference herein in its entirety.

### BACKGROUND

### 1. Technical Field

The present disclosure relates to an image generation method, an image generation system, and a recording medium storing a program.

### 2. Related Art

In recent years, projection mapping for performing a variety of performances by projecting various images from a projector onto an object having a three-dimensional shape has been spreading. In the following explanation, an object onto which an image is projected from a projector is referred to as projection target object. To perform the projection mapping, preparation for, for example, distorting the image projected from the projector into a three-dimensional shape of the projection target object is necessary. This is because distortion corresponding to the three-dimensional shape of the projection target object appears in the image reflected on the surface of the projection target object. Various techniques for supporting the preparation in the projection mapping have been proposed. Examples of the techniques include a technique disclosed in JP-A-2019-168640 (Patent Literature 1). In the technique disclosed in Patent Literature 1, an image for correction including a marker for position detection is projected onto a projection target object by a projector. The image for correction reflected on the surface of the projection target object is captured by a detection apparatus. The marker is detected from the captured image for correction. By correcting original image data based on a detection result of the marker, correction corresponding to the shape of the projection target object is applied to the image projected from the projector.

To appropriately give distortion corresponding to the three-dimensional shape of the projection target object to the image projected from the projector, the marker needs to be reflected in the image for correction properly and in an accurate shape. This is because, if the marker is not reflected in the image for correction properly and in an accurate shape, a trouble occurs in detection of the marker. That is, the technique disclosed in Patent Literature 1 is based on the premise that a user has certain expertise concerning the projection mapping such as expertise concerning imaging conditions such as a position and a direction of the detection apparatus that captures the image for correction. However, the user who intends to perform the projection mapping does not always have expertise concerning the projection mapping. The technique disclosed in Patent Literature 1 has a problem in that a user not having expertise concerning the projection mapping cannot easily realize the projection mapping.

### SUMMARY

According to an aspect of the present disclosure, there is provided an image generation method including: displaying a superimposed image obtained by superimposing a first image applied with transmission processing on a first captured image obtained by imaging, in a real space where a projector and a projection target object, which is a projection target of an image projected from the projector, are disposed, the projection target object with a camera and a user interface image for receiving an input for determining a position of the camera in the real space; generating a second image by correcting the first image according to a shape of the projection target object measured based on a second captured image obtained by imaging, from the position, with the camera, the projection target object onto which a pattern image is projected from the projector; and outputting image data representing the second image to the projector.

According to an aspect of the present disclosure, there is provided an image generation system including: a display apparatus; and a processing apparatus configured to control the display apparatus, the processing apparatus executing: causing the display apparatus to display a superimposed image obtained by superimposing a first image applied with transmission processing on a first captured image obtained by imaging, in a real space where a projector and a projection target object, which is a projection target of an image projected from the projector, are disposed, the projection target object with a camera and a user interface image for receiving an input for determining a position of the camera in the real space; generating a second image by correcting the first image according to a shape of the projection target object measured based on a second captured image obtained by imaging, from the position, with the camera, the projection target object onto which a pattern image is projected from the projector; and outputting image data representing the second image to the projector.

According to an aspect of the present disclosure, there is provided a non-transitory computer-readable recording medium storing a program for causing a computer to execute: causing the display apparatus to display a superimposed image obtained by superimposing a first image applied with transmission processing on a first captured image obtained by imaging, in a real space where a projector and a projection target object, which is a projection target of an image projected from the projector, are disposed, the projection target object with a camera and a user interface image for receiving an input for determining a position of the camera in the real space; generating a second image by correcting the first image according to a shape of the projection target object measured based on a second captured image obtained by imaging, from the position, with the camera, the projection target object onto which a pattern image is projected from the projector; and outputting image data representing the second image to the projector.

### BRIEF DESCRIPTION OF THE DRAWINGS

FIG. 1 is a diagram showing a configuration example of an image generation system according to a first embodiment of the present disclosure.

FIG. 2 is a diagram showing an example of an image represented by material data in the first embodiment.

FIG. 3 is a diagram showing a configuration example of an image processing apparatus.

FIG. 4 is a diagram showing an example of a superimposed image.

FIG. 5 is a diagram for explaining the superimposed image.

FIG. 6 is a diagram showing a display example of the superimposed image and a user interface image in the first embodiment.

FIG. 7 is a diagram for explaining an angle of view of a material image and an angle of view of a captured image.

FIG. 8 is a diagram showing an example of the superimposed image at the time when the angle of view of the material image and the angle of view of the captured image match.

FIG. 9 is a diagram showing an example of projection mapping realized by the first embodiment.

FIG. 10 is a flowchart showing a flow of an image generation method executed by a processing device of the image processing apparatus according to a program.

FIG. 11 is a diagram showing a configuration example of an image generation system according to a second embodiment of the present disclosure.

FIG. 12 is a diagram showing an example of an image represented by material data in the second embodiment.

FIG. 13 is a diagram showing a configuration example of an image processing apparatus.

FIG. 14 is a diagram showing a display example of a superimposed image and a user interface image in the second embodiment.

FIG. 15 is a diagram showing an example of a mask image.

FIG. 16 is a diagram showing an example of a projection image generated using the mask image.

FIG. 17 is a diagram showing an example of projection mapping realized in the second embodiment.

FIG. 18 is a flowchart showing a flow of an image generation method executed by a processing device of the image processing apparatus according to a program.

### DESCRIPTION OF EXEMPLARY EMBODIMENTS

Technically preferable various limitations are added to embodiments explained below. However, embodiments of the present disclosure are not limited to the embodiments explained below.

### 1. First Embodiment

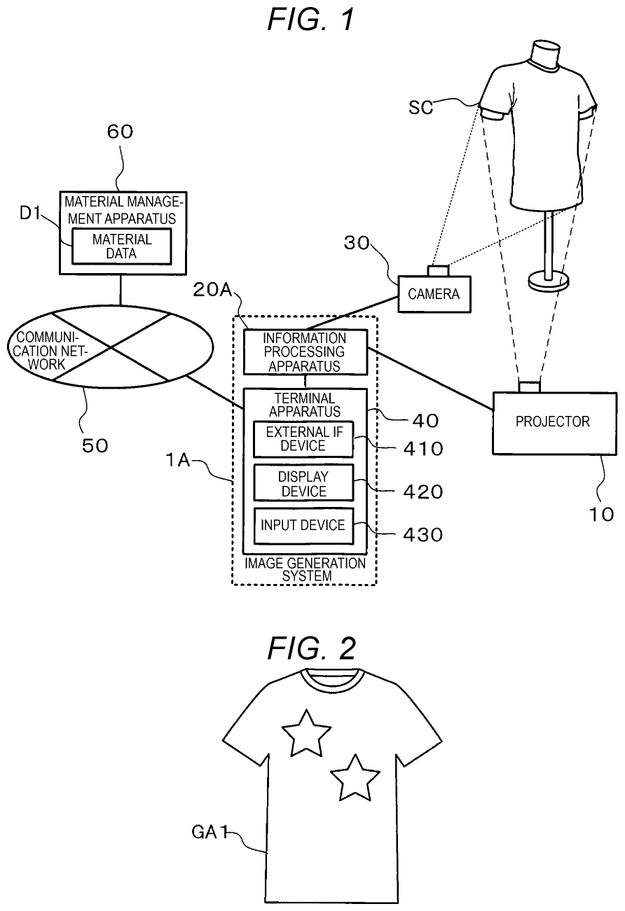

FIG. 1 is a diagram showing a configuration example of an image generation system 1A according to a first embodiment of the present disclosure. The image generation system 1A is an information processing system that generates image data representing a projection image projected onto a projection target object SC from a projector 10 in projection mapping. In the following explanation, the image data representing the projection image is referred to as projection image data. As shown in FIG. 1, the image generation system 1A includes an information processing apparatus 20A and a terminal apparatus 40. In FIG. 1, the projector 10, a camera 30, the projection target object SC, a communication network 50, and a material management apparatus 60 are illustrated besides the image generation system 1A.

The projection target object SC in this embodiment is a mannequin simulating the upper half of a human body and wearing a white and pattern-less T-shirt. The projection target object SC and the projector 10 are set in, for example, a selling floor of a retail store that sells clothes. In this embodiment, a projection image corresponding to a color and a pattern of a T-shirt is projected onto the projection target object SC from the projector 10, whereby a commodity display is simulatively realized by the projection mapping. In the following explanation, the store where the projection target object SC and the projector 10 are set is referred to as real store.

The information processing apparatus 20A is, for example, a stick-type personal computer. The information processing apparatus 20A includes a male connector conforming to a predetermined standard such as the USB (Universal Serial Bus). The projector 10 includes a female connector corresponding to the male connector. The male connector of the information processing apparatus 20A is inserted into the female connector of the projector 10, whereby the information processing apparatus 20A and the projector 10 are electrically connected. The information processing apparatus 20A communicates with the camera 30 and the terminal apparatus 40 by radio or wire.

The camera 30 is an apparatus for imaging the projection target object SC. The camera 30 is set in the real store using, for example, a tripod in a posture in which the optical axis of the camera 30 is directed to the projection target object SC. The camera 30 performs imaging under control by the information processing apparatus 20A and outputs image data representing a captured image to the information processing apparatus 20A. In the following explanation, the image data representing the captured image is referred to as captured image data.

The communication network 50 is an electric communication line such as the Internet. The material management apparatus 60 is connected to the communication network 50. The material management apparatus 60 is, for example, a data server. One or a plurality of material data D1 are stored in advance in the material management apparatus 60. The material data D1 is image data representing an image based on which a projection image projected onto the projection target object SC from the projector 10 is formed. In the following explanation, an image represented by material data is referred to as material image. The material image is an example of the first image in the present disclosure. FIG. 2 is a diagram showing an example of a material image GA1 in this embodiment. As shown in FIG. 2, the material image GA1 in this embodiment is an image of a T-shirt having a pattern. The material data D1 is created by a designer or the like in charge of design of the T-shirt and uploaded to the material management apparatus 60. The material data D1 uploaded to the material management apparatus 60 can be downloaded to the terminal apparatus 40 by communication via the communication network 50.

The terminal apparatus 40 is a smartphone used by a user of the projector 10. The user of the projector 10 in this embodiment is a store clerk working in the real store. As shown in FIG. 1, the terminal apparatus 40 includes an external IF device 410, a display device 420, and an input device 430.

The external IF device 410 includes a communication circuit that communicates with the material management apparatus 60 via the communication network 50 and communicates with the information processing apparatus 20A. IF is an abbreviation of Interface. The display device 420 includes a liquid crystal display and a driving circuit for the liquid crystal display. The terminal apparatus 40 causes the display device 420 to display various images under the control by the information processing apparatus 20A. The input device 430 is a transparent sheet-like pressure sensitive sensor provided to cover a surface region of the display device 420 and receives input operation of the user. The terminal apparatus 40 transmits, via the external IF device 410, to the information processing apparatus 20A, input operation data indicating input operation of the user to the input device 430. Consequently, the input operation of the user is transmitted to the information processing apparatus 20A.

As explained in detail below, the information processing apparatus 20A performs, according to the input operation to the terminal apparatus 40, imaging by the camera 30, generation of projection image data based on captured image data acquired from the camera 30 and the material data D1 downloaded to the terminal apparatus 40, and output of the generated projection image data to the projector 10. A projection image represented by the projection image data generated by the information processing apparatus 20A is projected onto the projection target object SC from the projector 10, whereby commodity display by the projection mapping is realized.

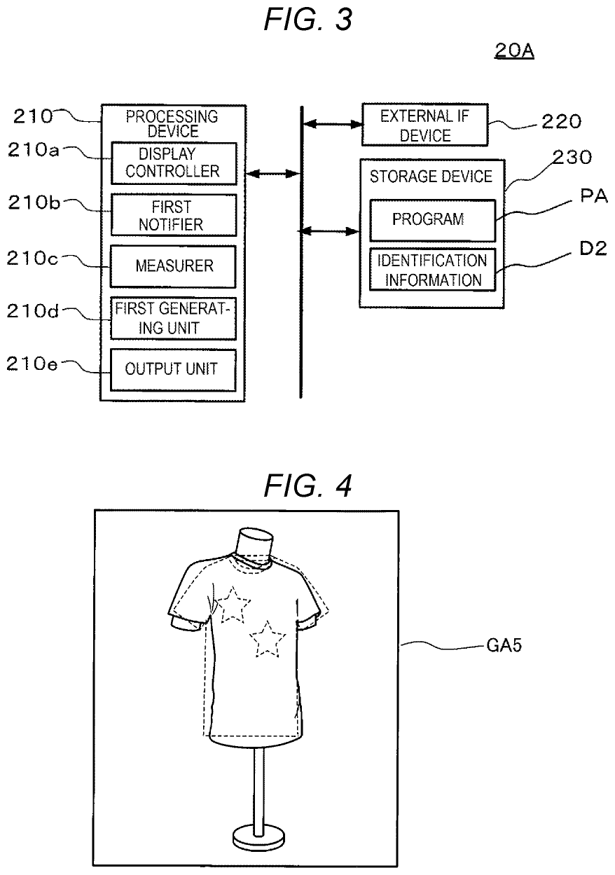

FIG. 3 is a diagram showing a configuration example of the information processing apparatus 20A. As shown in FIG. 3, the information processing apparatus 20A includes a processing device 210, an external IF device 220, and a storage device 230. The processing device 210 includes a processor such as a CPU (Central Processing Unit), that is, a computer. The processing device 210 may be configured by a single processor or may be configured by a plurality of processors. The processing device 210 operates according to a program PA stored in the storage device 230 to thereby function as a control center of the information processing apparatus 20A.

The external IF device 220 includes the male connector explained above. In a state in which the male connector is inserted into the female connector of the projector 10 and the information processing apparatus 20A and the projector 10 are electrically connected, the external IF device 220 outputs, to the projector 10, data or a signal given from the processing device 210. The external IF device 220 includes a communication circuit that communicates with the camera 30 or the terminal apparatus 40.

The storage device 230 is a recording medium readable by the processing device 210. The storage device 230 includes, for example, a nonvolatile memory and a volatile memory. The nonvolatile memory is, for example, a ROM (Read Only Memory), an EPROM (Erasable Programmable Read Only Memory), or an EEPROM (Electrically Erasable Programmable Read Only Memory). The volatile memory is, for example, a RAM (Random Access Memory).

The program PA for causing the processing device 210 to execute the image generation method of the present disclose is stored in advance in the nonvolatile memory of the storage device 230. Identification information D2 uniquely indicating the material management apparatus 60 in the communication network 50 is stored in advance in the nonvolatile memory of the storage device 230. Specific examples of the identification information D2 include a communication address allocated to the material management apparatus 60. The volatile memory of the storage device 230 is used by the processing device 210 as a work area in executing the program PA.

When detecting the connection of the information processing apparatus 20A and the projector 10, the processing device 210 reads out the program PA from the nonvolatile memory to the volatile memory and starts execution of the read-out program PA. When detecting connection of the terminal apparatus 40 and the camera 30 to the external IF device 410, the processing device 210 operating according to the program PA transmits the identification information D2 to the terminal apparatus 40. Consequently, the terminal apparatus 40 acquires the identification information D2.

When the identification information D2 is acquired by the terminal apparatus 40, the user accesses the material management apparatus 60 using the identification information D2 and downloads the material data D1 representing a desired material image from the material management apparatus 60 to the terminal apparatus 40 to acquire the material data D1. When detecting the acquisition of the material data D1 by the terminal apparatus 40, the processing device 210 operating according to the program PA functions as a display controller 210a, a first notifier 210b, a measurer 210c, a first generating unit 210d, and an output unit 210e. The display controller 210a, the first notifier 210b, the measurer 210c, the first generating unit 210d, and the output unit 210e shown in FIG. 3 are software modules realized by causing the processing device 210 to operate according to the program PA. Functions respectively performed by the display controller 210a, the first notifier 210b, the measurer 210c, the first generating unit 210d, and the output unit 210e are as explained below.

The display controller 210a causes the camera 30 to perform imaging at a predetermined period such as a one millisecond interval. In this embodiment, since the camera 30 is set in the real store in the posture in which the optical axis is directed to the projection target object SC, the camera 30 images the projection target object SC. A captured image of the projection target object SC imaged by the camera 30 under control by the display controller 210a is an example of the first captured image in the present disclosure. The display controller 210a acquires captured image data from the camera 30 every time the display controller 210a causes the camera 30 to perform imaging. Every time the display controller 210a acquires the captured image data, the display controller 210a generates, based on the material data D1 downloaded to the terminal apparatus 40 and the acquired captured image data, image data representing a superimposed image GA5.

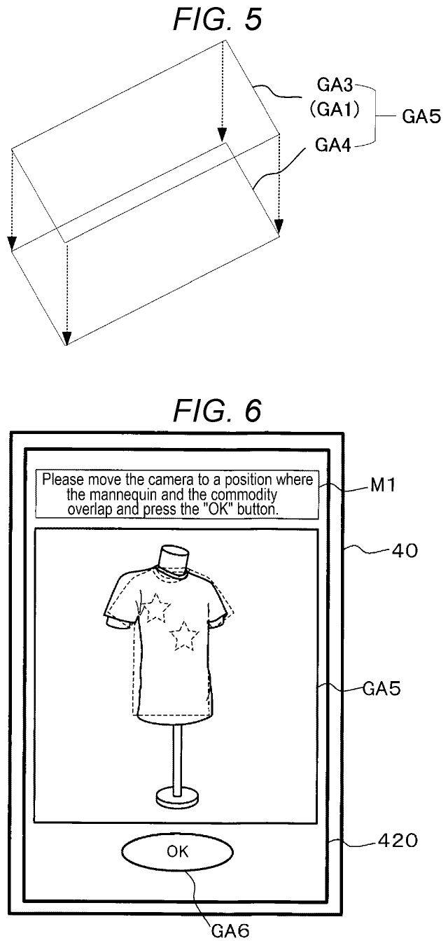

FIG. 4 is a diagram showing an example of the superimposed image GA5. FIG. 5 is a diagram for explaining the superimposed image GA5. As shown in FIG. 5, the superimposed image GA5 is generated by superimposing, on a captured image GA4 represented by the captured image data, an image GA3 obtained by applying transmission processing to the material image GA1 represented by the material data D1. The transmission processing is processing for setting the transmittance of the material image GA1 to transmittance larger than 0% and smaller than 100%. The material image GA1 less easily transmits light as the transmittance is closer to 0% and more easily transmits light as the transmittance is closer to 100%. The material image GA1 applied with the transmission processing becomes semitransparent. In the example shown in FIG. 4, a contour line of a T-shirt reflected in the material image GA1 and a contour line of a pattern given to the T-shirt are drawn by dotted lines to express that the material image GA1 is semitransparent. Since the material image GA1 is semitransparent in the superimposed image GA5, the user can visually recognize the captured image GA4 through the semitransparent material image GA1. The transmittance in the transmission processing only has to be transmittance at which the captured image GA4 can be visually recognized through the material image GA1 and may be, for example, in a range of 10% to 90%. The user may be able to adjust the transmittance using a not-shown user interface.

The display controller 210a gives the generated image data to the terminal apparatus 40 and causes the display device 420 to display the superimposed image GA5. The display controller 210a causes the display device 420 to display, together with the superimposed image GA5, a user interface image GA6 for receiving input operation for determining a position of the camera 30 in the real store, that is, a position of the camera 30 in a real space. FIG. 6 is a diagram showing a display example of the superimposed image GA5 and the user interface image GA6. The user interface image GA6 in the example shown in FIG. 6 is an image of a virtual operation piece that receives a touch of the user.

The first notifier 210b outputs a notification for requesting the user to determine, as the position of the camera 30, a position where an angle of view of the material image GA1 in the superimposed image GA5 and an angle of view of the captured image GA4 in the superimposed image GA5 match. In this embodiment, as shown in FIG. 6, the first notifier 210b causes the display device 420 to display a message M1 “Please move the camera to a position where the mannequin and the commodity overlap and press the “OK” button”. In this embodiment, the notification is performed by displaying the message M1. However, the notification may be performed by output of voice representing the message M1.

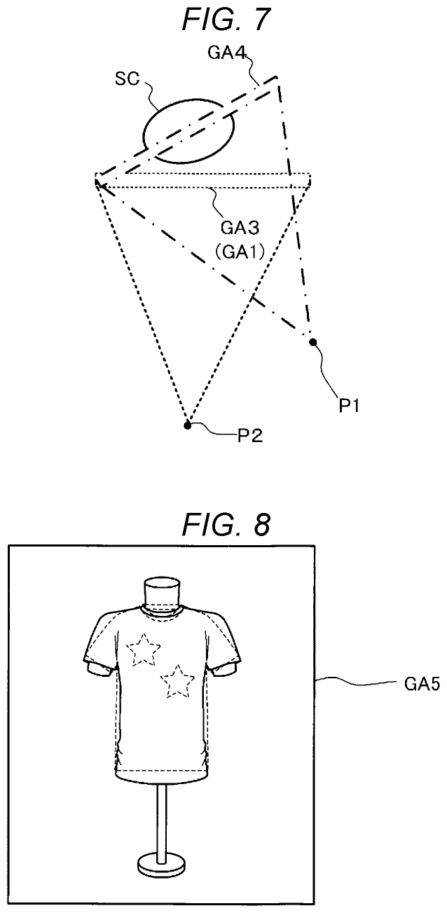

FIG. 7 is a diagram showing an example of the angle of view of the material image GA1 in the superimposed image GA5 and the angle of view of the captured image GA4 in the superimposed image GA5. The angle of view of the material image GA1 means a visual field range of a camera at the time when the camera captured the material image GA1. The material image GA1 may be an image obtained by imaging a real object of clothes or may be created as an image. When the material image GA1 is not the image obtained by imaging the real object, a visual field range of a virtual camera where the clothes are seen as in the material image GA1 corresponds to the angle of view of the material image GA1. The angle of view of the captured image GA4 means a visual field range of the camera 30 at the time when the camera 30 captured the captured image GA4. An angle of view is decided according to the position of a camera and the direction of the optical axis of the camera. In FIG. 7, the angle of view of the material image GA1 is drawn by a dotted line and the angle of view of the captured image GA4 is drawn by an alternate long and short dash line. In the example shown in FIG. 7, the position of the camera 30 at the time when the camera 30 captured the captured image GA4 is a position Pl. When the camera 30 moves to a position P2, the angle of view of the material image GA1 and the angle of view of the captured image GA4 substantially coincide. That is, in the example shown in FIG. 7, the position P2 is the position of the camera 30 where the angle of view of the material image GA1 in the superimposed image GA5 and the angle of view of the captured image GA4 in the superimposed image GA5 match.

The user who has visually recognized the message M1 carries the camera 30 and moves while checking the angle of view of the material image GA1 and the angle of view of the captured image GA4 through the superimposed image GA5 displayed on the display device 420 of the terminal apparatus 40. According to the movement of the camera 30, the angle of view of the captured image GA4 included in the superimposed image GA5 displayed on the display device 420 changes. For example, when the camera 30 moves to the position P2, the superimposed image GA5 shown in FIG. 8 is displayed on the display device 420. At the opportunity when the angle of view of the material image GA1 and the angle of view of the captured image GA4 match, the user stops the movement of the camera 30 and touches the user interface image GA6.

When the user interface image GA6 is touched, the measurer 210c executes three-dimensional measurement for measuring the shape of the projection target object SC. More specifically, the measurer 210c outputs, to the projector 10, a signal for instructing the projector 10 to project a series of pattern images for measuring a three-dimensional shape of an object. Specific examples of the pattern images include a pattern image for coding a space of, for example, an image representing a gray code pattern and a pattern image representing a sine wave pattern. The measurer 210c outputs a signal for instructing imaging to the camera 30 in synchronization with the output of the signal for instructing the projection of the pattern images, that is, at timing delayed by a predetermined time from the output of the signal for instructing the projection of the pattern images. Consequently, the projection target object SC onto which the series of pattern images are projected from the projector 10 is imaged for each of the pattern images by the camera 30 disposed in a position determined by the touch. In the example shown in FIG. 7, since the touch is performed in the position P2, the imaging is performed by the camera 30 disposed in the position P2.

The measurer 210c generates, based on the series of pattern images and a series of captured images obtained by imaging, with the camera 30, from the position determined by the touch, for each of the pattern images, the projection target object SC onto which the series of pattern images are projected from the projector 10, conversion data for mutually coordinate-converting a camera coordinate system and a world coordinate system. In other words, the measurer 210c measures the shape of the projection target object SC based on a captured image obtained by imaging the projection target object SC onto which the pattern images are projected from the projector 10. The generating the conversion data is equivalent to the measuring the shape of the projection target object SC. The series of captured images obtained by imaging, with the camera 30, from the position determined by the touch, for each of the pattern images, the projection target object SC onto which the series of pattern images are projected from the projector 10 are an example of the second captured image in the present disclosure. The camera coordinate system is a two-dimensional coordinate system that specifies a position in a captured image of a camera. The world coordinate system is a three-dimensional coordinate system that specifies a position in the real space. As a specific algorithm for generating the conversion data from the series of pattern images, an existing algorithm only has to be used as appropriate according to a type of the pattern images.

The first generating unit 210d applies the coordinate conversion indicated by the conversion data to the material image GA1 represented by the material data D1 to thereby generate projection image data. The applying the coordinate conversion indicated by the conversion data to the material image GA1 is equivalent to correcting the material image GA1 according to the shape of the projection target object SC. The output unit 210e outputs the projection image data to the projector 10. The projector 10 projects a projection image represented by the projection image data output from the information processing apparatus 20A onto the projection target object SC. The projection image is an example of the second image in the present disclosure.

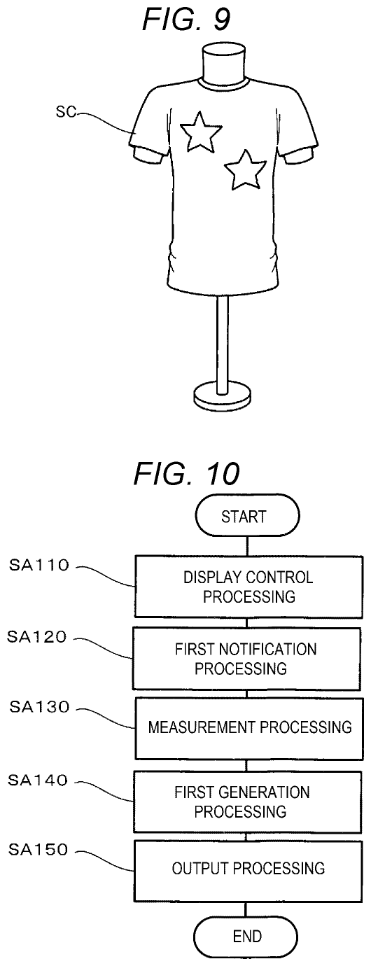

In this embodiment, the camera 30 is disposed in the position where the angle of view of the captured image GA4 and the angle of view of the material image GA1 match. The angle of view of the captured image GA4 and the angle of view of the material image GA1 matching means that the position of a camera with respect to an object at the time when the camera captured the material image GA1 and the position of the camera 30 with respect to the projection target object SC are generally the same and the direction of the optical axis of the camera at the time when the camera captured the material image GA1 and the direction of the optical axis of the camera 30 are generally the same. Therefore, the angle of view of the captured image GA4 and the angle of view of the material image GA1 matching means that a camera coordinate system about the camera 30 and a camera coordinate system of the camera that captured the material image GA1 substantially coincide. Since the camera coordinate system about the camera 30 is converted into a world coordinate system based on the conversion data, the camera coordinate system of the camera that captured the material image GA1 is also converted into a world coordinate system based on the conversion data. Distortion corresponding to the shape of the projection target object SC is given to the material image GA1 after the conversion. Therefore, as shown in FIG. 9, the material image GA1 is reflected on the surface of the projection target object SC substantially without distortion.

The processing device 210 operating according to the program PA executes an image generation method shown in FIG. 10. As shown in FIG. 10, the image generation method in this embodiment includes display control processing SA110, first notification processing SA120, measurement processing SA130, first generation processing SA140, and output processing SA150.

In the display control processing SA110, the processing device 210 functions as the display controller 210a. In the display control processing SA110, the processing device 210 causes the display device 420 to display the superimposed image GA5 based on the material data D1 downloaded to the terminal apparatus 40 and the captured image data acquired from the camera 30 and causes the display device 420 to display the user interface image GA6.

In the first notification processing SA120, the processing device 210 functions as the first notifier 210b. In the first notification processing SA120, the processing device 210 causes the display device 420 to display the message M1 for requesting the user to determine, as the position of the camera 30, the position where the angle of view of the material image GA1 and the angle of view of the captured image GA4 match.

In the measurement processing SA130, the processing device 210 functions as the measurer 210c. In the measurement processing SA130, the processing device 210 performs three-dimensional measurement for measuring the shape of the projection target object SC and generates conversion data for mutually coordinate-converting a camera coordinate system of the camera 30 and a world coordinate system.

In the first generation processing SA140, the processing device 210 functions as the first generating unit 210d. In the first generation processing SA140, the processing device 210 applies the coordinate conversion indicated by the conversion data generated in the measurement processing SA130 to the material data D1 downloaded to the terminal apparatus 40 to thereby generate projection image data.

In the output processing SA150, the processing device 210 functions as the output unit 210e. In the output processing SA150, the processing device 210 outputs the projection image data generated in the first generation processing SA140 to the projector 10. The projector 10 projects a projection image represented by the projection image data output from the information processing apparatus 20A onto the projection target object SC. The projection image represented by the projection image data is projected onto the projection target object SC from the projector 10, whereby, as shown in FIG. 9, the material image GA1 is reflected on the surface of the projection target object SC without distortion.

What should be noted here is that the user of the projector 10 is requested to download the material data D1 and determine and touch the position of the camera 30 according to the message M1. Expertise concerning the projection mapping is unnecessary. As explained above, according to this embodiment, even if a store clerk of a retail store does not have expertise concerning the projection mapping, the store clerk is capable of easily performing commodity display by the projection mapping.

In addition, when commodity display concerning clothes is realized by the projection mapping, it is unnecessary to prepare, for each of colors and each of patterns of commodities, commodity samples for the commodity display. In a retail store or the like, selection of goods has been changed in change of seasons and the like. After the change of the selection of goods, old commodity samples have become unnecessary. The unnecessary commodity samples have been sometimes sold at low prices but most of the unnecessary commodity samples have been discarded. Such discarding of the commodity samples is a problem from the viewpoint of effective use of resources. According to this embodiment, waste of resources is reduced.

### 2. Second Embodiment

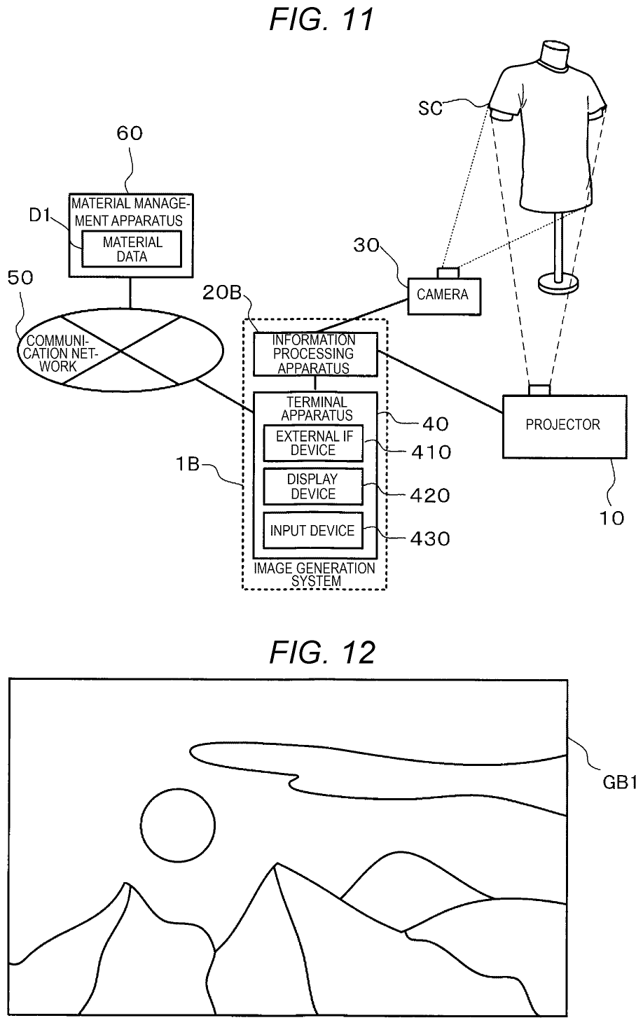

FIG. 11 is a diagram showing a configuration example of an image generation system 1B according to a second embodiment of the present disclosure. In FIG. 11, the same components as the components shown in FIG. 1 are denoted by the same reference numerals and signs. In FIG. 11, as in FIG. 1, the projection target object SC, the projector 10, the camera 30, the communication network 50, and the material management apparatus 60 are illustrated besides the image generation system 1B. As it is evident if FIG. 11 and FIG. 1 are compared, the configuration of the image generation system 1B is different from the configuration of the image generation system 1A in that the image generation system 1B includes an information processing apparatus 20B instead of the information processing apparatus 20A. That is, the image generation system 1B includes the information processing apparatus 20B and the terminal apparatus 40. In this embodiment, the material data D1 stored in the material management apparatus 60 is image data representing an image representing a pattern like cloth or wallpaper, an image of an animal or a person, or a scenery image. A material image GB1 represented by the material data D1 in this embodiment is, as shown in FIG. 12, a scenery image in which a plurality of mountains, a cloud floating in the sky, and the sun are reflected.

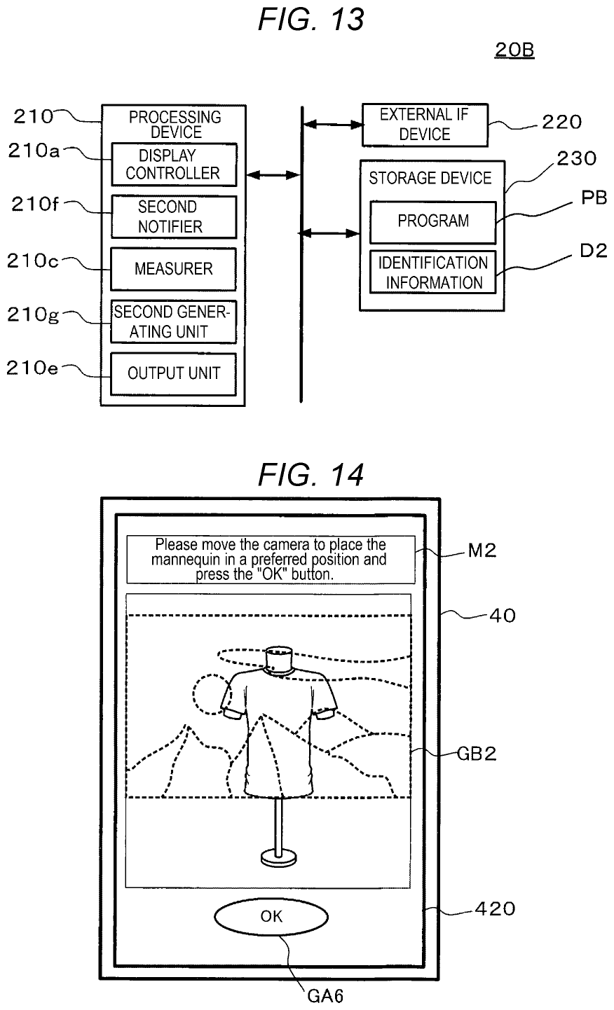

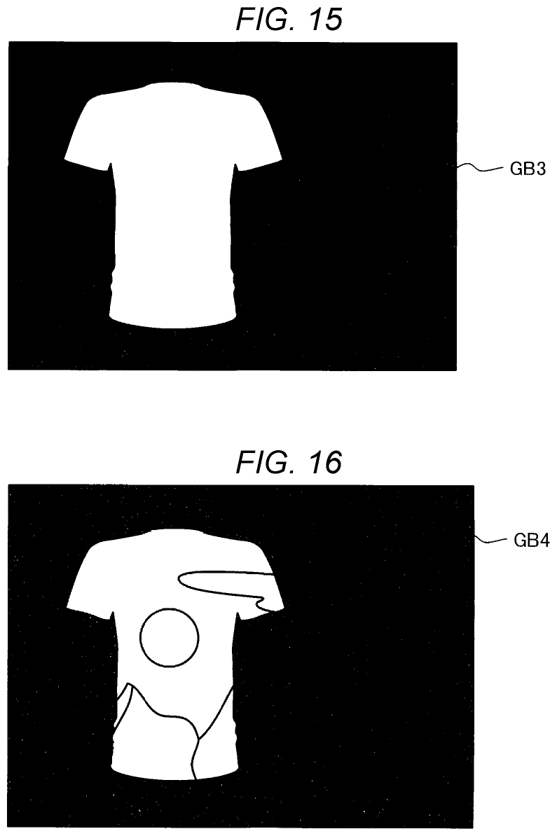

The information processing apparatus 20B is a stick-type personal computer as in the information processing apparatus 20A. FIG. 13 is a diagram showing a configuration example of the information processing apparatus 20B. In FIG. 13, the same components as the components shown in FIG. 3 are denoted by the same reference numerals and signs. As it is evident if FIG. 13 and FIG. 3 are compared, a hardware configuration of the information processing apparatus 20B is the same as the hardware configuration of the information processing apparatus 20A. That is, the information processing apparatus 20B includes the processing device 210, the external IF device 220, and the storage device 230. The configuration of the information processing apparatus 20B is different from the configuration of the information processing apparatus 20A in that a program PB is stored in the storage device 230 instead of the program PA. The processing device 210 operating according to the program PB functions as the display controller 210a, a second notifier 210f, the measurer 210c, a second generating unit 210g, and the output unit 210e.

The configuration of the information processing apparatus 20B is different from the configuration of the information processing apparatus 20A in that the second notifier 210f is provided instead of the first notifier 210b and the second generating unit 210g is provided instead of the first generating unit 210d. However, in this embodiment, since the material image GB1 is the scenery image, a superimposed image GB2 that the display controller 210a causes the display device 420 to display is also different from the superimposed image GA5 in the first embodiment. The superimposed image GB2 is an image obtained by superimposing, on the captured image GA4, an image obtained by applying transmission processing to the material image GB1. FIG. 14 is a diagram showing a display example of the superimposed image GB2 and the user interface image GA6. In the example shown in FIG. 14, respective contour lines of a plurality of mountains, clouds, and the sun reflected in the material image GB1 are drawn by dotted lines to express that the material image GB1 is semitransparent. In the superimposed image GB2, since the material image GB1 is semitransparent, the user can visually recognize the captured image GA4 through the semitransparent material image GB1.

The second notifier 210f outputs a notification for requesting the user to determine a position of the camera 30 such that the projection target object SC reflected in the captured image GA4 occupies a predetermined position in the material image GB1. In this embodiment, the second notifier 210f causes the display device 420 to display a message M2 “Please move the camera to place the mannequin in a preferred position and press the “OK” button” as shown in FIG. 14. In this embodiment, the notification is performed by displaying the message M2. However, the notification may be performed by output of voice representing the message M2. The user who has visually recognized the message M2 carries the camera 30 and moves while checking the position of the projection target object SC with respect to the material image GB1 through the superimposed image GB2 displayed on the display device 420. According to the movement of the camera 30, the position of the projection target object SC with respect to the material image GB1 changes. At the opportunity when the projection target object SC occupies a desired position with respect to the material image GB1, the user stops the movement of the camera 30 and touches the user interface image GA6. When the user interface image GA6 is touched, the three-dimensional measurement explained above is executed by the measurer 210c.

The second generating unit 210g generates, based on any one of a series of captured images captured in a process for executing the three-dimensional measurement, mask image data representing a mask image GB3 for extracting a region corresponding to the projection target object SC from the material image GB1. Specific examples of the mask image GB3 include an image obtained by applying transparent processing to a region corresponding to the projection target object SC in a projection image or processing for making the region transparent and painting out a portion other than the region in black. The second generating unit 210g superimposes the mask image GB3 represented by the mask image data on the material image GB1 to thereby acquire a masked material image GB4 obtained by painting out, in black, a portion other than the region corresponding to the projection target object SC in the material image GB1. FIG. 16 is a diagram showing an example of the masked material image GB4. The second generating unit 210g applies coordinate conversion indicated by conversion data to image data representing the masked material image GB4 to thereby generate projection image data.

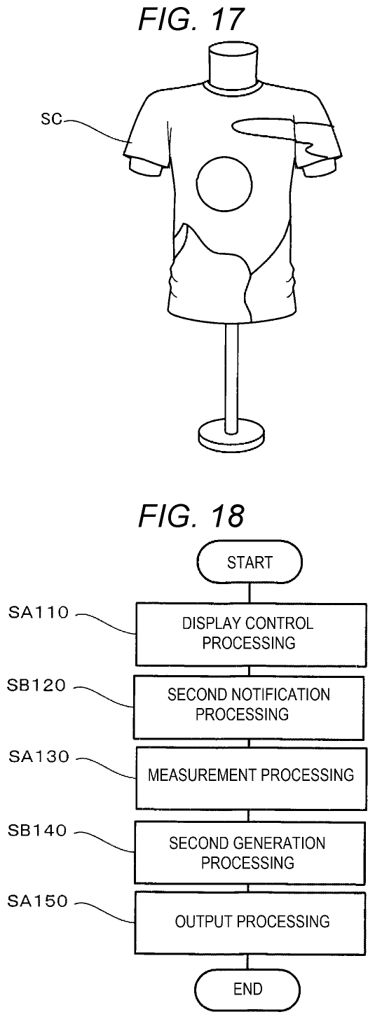

The projection image data generated by the second generating unit 210g is output to the projector 10 by the output unit 210e. The projector 10 projects a projection image represented by the projection image data output from the information processing apparatus 20B onto the projection target object SC. As a result, as shown in FIG. 17, a part of the material image GB1 is reflected on the surface of the projection target object SC without distortion as if the part of the material image GB1 is a pattern of a T-shirt.

The processing device 210 operating according to the program PB executes an image generation method shown in FIG. 18. As shown in FIG. 18, the image generation method in this embodiment includes the display control processing SA110, second notification processing SB120, the measurement processing SA130, second generation processing SB140, and the output processing SA150. Respective processing contents of the second notification processing SB120 and the second generation processing SB140, which are differences between the image generation method in this embodiment and the image generation method in the first embodiment, are as explained below.

In the second notification processing SB120, the processing device 210 functions as the second notifier 210f. In the second notification processing SB120, the processing device 210 causes the display device 420 to display the message M2 for requesting the user to determine the position of the camera 30 such that the projection target object SC reflected in a captured image occupies a desired position in the material image GB1.

In the second generation processing SB140, the processing device 210 functions as the second generating unit 210g. In the second generation processing SB140, the processing device 210 generates the mask image GB3 based on any one of a series of captured images captured in a process for executing the measurement processing SA130. Subsequently, the processing device 210 superimposes the mask image GB3 on the material image GB1 to thereby generate the masked material image GB4 obtained by painting out, in black, a portion other than the region corresponding to the projection target object SC in the material image GB1. The processing device 210 applies the coordinate conversion indicate by the conversion data generated in the measurement processing SA130 to image data representing the masked material image GB4 to thereby generate projection image data.

The projection image data generated in the second generation processing SB140 is output to the projector 10 in the output processing SA150. A projection image represented by the projection image data is projected onto the projection target object SC from the projector 10, whereby, as shown in FIG. 17, a part of the material image GB1 is reflected on the surface of the projection target object SC without distortion as if the part of the material image GB1 is a pattern of a T-shirt.

As explained above, according to this embodiment, even if a store clerk of a retail store does not have expertise concerning the projection mapping, the store clerk is capable of easily performing commodity display by the projection mapping. According to this embodiment as well, since it is unnecessary to prepare commodity samples for each of colors and each of patterns of commodities, waste of resources is reduced.

### 3. Modifications

The embodiments explained above can be modified as explained below.

(1) In the embodiments explained above, an application example of the present disclosure to the projection mapping for realizing commodity display for clothes is explained. However, the present disclosure may be applied to projection mapping for realizing commodity display of commodities other than clothes and may be applied to projection mapping for realizing performances in a theme park, an event venue, or the like. By applying the present disclosure, a user not having expertise concerning the projection mapping is capable of realizing the projection mapping for realizing performances in a theme park, an event venue, or the like.

(2) In the embodiments explained above, one projector 10 projects the projection image onto one projection target object SC. However, a plurality of projectors 10 respectively disposed in different positions may project projection images onto one projection target object SC. Since the projection images are projected onto the one projection target object SC from the plurality of projectors 10 respectively disposed in the different positions, projection mapping with increased brightness can be realized. Since the projection images are projected onto the one projection target object SC from the plurality of projectors 10 respectively disposed in the different positions, projection mapping that can reduce shadow as much as possible and can be seen from anywhere in 360° can be realized.

(3) The first notification processing SA120 in the first embodiment may be omitted. In an aspect in which the first notification processing SA120 is omitted, the first notifier 210b may be omitted. This is because a projection image can be still accurately and easily created even if the first notification processing SA120 is omitted. Similarly, the second notification processing SB120 in the second embodiment can also be omitted. The second notifier 210f can also be omitted. When conversion data can be separately acquired, the measurement processing SA130 and the measurer 210c can also be omitted.

(4) The information processing apparatus 20A may include a storage controller that causes a storage device to store the projection image data generated by the first generating unit 210d. According to this aspect, it is possible to reuse the projection image data. Specific examples of the storage device in which the projection image data is stored include the storage device 230 included in the information processing apparatus 20A, the material management apparatus 60, and a hard disk device accessible by the processing device 210 through communication via the communication network 50. Similarly, the information processing apparatus 20B may include a storage controller that causes the storage device to store the projection image data generated by the second generating unit 210g.

In an aspect of causing the storage device to store the projection image data, it is possible to generate, based on a plurality of projection image data stored in the storage device, moving image data in which projection images represented by the projection image data are arrayed in a time axis direction and cause the projector 10 to sequentially project the projection images according to the moving image data as time elapses. Data representing a new projection image obtained by arranging, in parallel, the projection images represented by the respective plurality of projection image data, superimposing the projection images, or the like, may be generated based on the plurality of projection image data.

(5) In the embodiments explained above, the camera 30 and the terminal apparatus 40 are the separate apparatuses. However, the camera 30 may be included in the terminal apparatus 40. For example, when the terminal apparatus 40 is a smartphone including a camera, the camera of the smartphone only has to play a role of the camera 30. In the first embodiment, the information processing apparatus 20A is an apparatus different from all of the terminal apparatus 40, the camera 30, and the projector 10. However, the information processing apparatus 20A may be included in any of the terminal apparatus 40, the camera 30, and the projector 10. Similarly, the information processing apparatus 20B may be included in any of the terminal apparatus 40, the camera 30, and the projector 10. In short, the image generation system according to the present disclosure only has to include a display apparatus and a processing apparatus that executes the display control processing SA110, one of the first generation processing SA140 and the second generation processing SB140, and the output processing SA150.

(6) The display controller 210a, the first notifier 210b, the measurer 210c, the first generating unit 210d, and the output unit 210e in the first embodiment are the software modules. However, any one of, a plurality of, or all of the display controller 210a, the first notifier 210b, the measurer 210c, the first generating unit 210d, and the output unit 210e may be hardware modules such as an ASIC (Application Specific Integrated Circuit). Even if any one of, a plurality of, or all of the display controller 210a, the first notifier 210b, the measurer 210c, the first generating unit 210d, and the output unit 210e are hardware modules, the same effects as the effects in the first embodiment are achieved. Similarly, any one of, a plurality of, or all of the display controller 210a, the second notifier 210f, the measurer 210c, the second generating unit 210g, and the output unit 210e in the second embodiment may be hardware modules.

(7) The program PA may be manufactured alone or may be provided with or without charge. Examples of a specific aspect in providing the program PA include an aspect of writing the program PA in a computer-readable recording medium such as a flash ROM and providing the program PA and an aspect of providing the program PA by downloading the program PA through an electric communication line such as the Internet. By causing a general computer to operate according to the program PA provided by these aspects, it is possible to cause the computer to execute the image generation method according to the present disclosure. Similarly, the program PB may be manufactured alone or may be provided with or without charge.

(8) In the embodiments explained above, the identification information D2 is stored in the storage device 230. However, an aspect of sticking, to a housing of the information processing apparatus 20A, the information processing apparatus 20B, or the projector 10, a print on which a two-dimensional barcode corresponding to the identification information D2 is printed and causing the terminal apparatus 40 to acquire the identification information D2 by reading the two-dimensional barcode from the print may be adopted.

### 4. An Aspect Grasped From at Least one of the Embodiments and the Modifications

The present disclosure is not limited to the embodiments and the modifications explained above and can be realized in various aspects in a range not departing from the gist of the present disclosure. For example, the present disclosure can also be realized by the following aspects. Technical features in the embodiments corresponding to technical features in the aspects described below can be substituted or combined as appropriate in order to solve a part or all of the problems of the present disclosure or achieve a part or all of the effects of the present disclosure. Unless the technical features are explained as essential technical features in this specification, the technical features can be deleted as appropriate.

An image generation method according to an aspect of the present disclosure includes display control processing, generation processing, and output processing. The display control processing is processing for displaying a superimposed image obtained by superimposing a first image applied with transmission processing on a first captured image and a user interface image. The first captured image is obtained by imaging, with a camera, a projection target object in a real space where a projector and the projection target object, which is a projection target of an image from the projector, are disposed. The user interface image is an image for receiving an input for determining a position of the camera, which captures the first captured image, in the real space where the projector and the projection target object, which is the projection target of the image from the projector, are disposed. The generation processing is processing for generating a second image by correcting the first image according to a measurement result of a shape of the projection target object. Both of the first generation processing SA140 in the first embodiment and the second generation processing SB140 in the second embodiment are an aspect of the generation processing in the present disclosure. In the generation processing, the shape of the projection target object may be measured based on a second captured image obtained by imaging, with the camera, from a position determined by an input to the user interface image, the projection target object onto which a pattern image for measuring a shape is projected from the projector. The output processing is processing for outputting image data representing the second image to the projector. With the image generation method according to this aspect, even a user not having expertise is capable of easily performing projection mapping.

An image generation method according to a more preferable aspect may include notification processing for outputting a notification for requesting a user to determine, as the position of the camera, a position where an angle of view of the first image and an angle of view of the first captured image match. The first notification processing SA120 in the first embodiment is an aspect of the notification processing in the present disclosure. According to this aspect, it is possible to request the user to match the angle of view of the first image and the angle of view of the first captured image.

The generation processing in the image generation method in the more preferable aspect may include: generating, based on the second captured image, a mask image for extracting a region corresponding to the projection target object from the first image; and superimposing the mask image on the first image to thereby generate the first image in which a region other than a region corresponding to the projection target object is masked. The generating the second image by correcting the first image in this aspect is generating the second image by correcting, according to the shape of the projection target object, the first image in which the region other than the region corresponding to the projection target object is masked. According to this aspect, it is possible to extract the region corresponding to the projection target object from the first image and generate the second image.

An image generation method according to a more preferable aspect may further include, when an input for determining the position of the camera is received, outputting, to the projector, a signal for instructing the projector to project the pattern image. According to this aspect, at the opportunity of the input for determining the position of the camera, it is possible to start three-dimensional measurement about the projection target object.

An image generation method according to a more preferable aspect may further include storage processing for storing the image data representing the second image in a storage device. According to this aspect, it is possible to create a new projection image using the image data stored in the storage device.

An image generation system according to an aspect of the present disclosure includes: a display apparatus; and a processing apparatus configured to control the display apparatus. The processing apparatus executes the display control processing, the generation processing, and the output processing explained above. With the image generation system according to this aspect, even a user not having expertise is capable of easily performing projection mapping.

A non-transitory computer-readable recording medium according to an aspect of the present disclosure stores a program for causing a computer to execute the display control processing, the generation processing, and the output processing explained above. With the recording medium recording the program according to this aspect, even a user not having expertise is capable of easily performing projection mapping.

What is claimed is:

1. An image generation method comprising:
displaying
a superimposed image obtained by superimposing a first image to which transmission processing is applied on a first captured image obtained by imaging, in a real space where a projector and a projection target object are disposed, the projection target object with a camera, the projection target object being a projection target of an image projected from the projector, and
a user interface image for receiving an input for determining a position of the camera in the real space;
generating a second image by correcting the first image according to a shape of the projection target object measured based on a second captured image obtained by imaging, from the position, with the camera, the projection target object onto which a pattern image is projected from the projector; and
outputting image data representing the second image to the projector.

2. The image generation method according to claim 1, further comprising outputting a notification for requesting a user to move the camera to a position where an angle of view of the first image and an angle of view of the first captured image match.

3. The image generation method according to claim 1, wherein
the generating the second image includes:
generating, based on the second captured image, a mask image for extracting a region corresponding to the projection target object from the first image; and
generating, using the mask image, the first image in which a region other than the region corresponding to the projection target object is masked, and
the correcting the first image according to the shape of the projection target object is correcting, according to the shape of the projection target object, the first image in which the region other than the region corresponding to the projection target object is masked.

4. The image generation method according to claim 1, further comprising, when receiving the input, outputting, to the projector, a signal for instructing the projector to project the pattern image.

5. The image generation method according to claim 1, further comprising storing the image data in a storage device.

6. An image generation system comprising:
a display apparatus; and
a processing apparatus configured to control the display apparatus,
the processing apparatus executing:
causing the display apparatus to display
a superimposed image obtained by superimposing a first image to which transmission processing is applied on a first captured image obtained by imaging, in a real space where a projector and a projection target object are disposed, the projection target object with a camera, the projection target object being a projection target of an image projected from the projector, and
a user interface image for receiving an input for determining a position of the camera in the real space;
generating a second image by correcting the first image according to a shape of the projection target object measured based on a second captured image obtained by imaging, from the position, with the camera, the projection target object onto which a pattern image is projected from the projector; and
outputting image data representing the second image to the projector.

7. A non-transitory computer-readable recording medium storing a program for causing a computer to execute:
causing a display apparatus to display
a superimposed image obtained by superimposing a first image to which transmission processing is applied on a first captured image obtained by imaging, in a real space where a projector and a projection target object are disposed, the projection target object with a camera, the projection target object being a projection target of an image projected from the projector, and
a user interface image for receiving an input for determining a position of the camera in the real space;
generating a second image by correcting the first image according to a shape of the projection target object measured based on a second captured image obtained by imaging, from the position, with the camera, the projection target object onto which a pattern image is projected from the projector; and
outputting image data representing the second image to the projector.
